(19) United States
(12) Patent Application Publication
(10) Pub. No.: US 2025/0236234 A1
(43) Pub. Date: Jul. 24, 2025

(54) Adjustable strap that has a T-shaped handle and hook

(71) Applicant: Stefan Simkovics, San Diego, CA (US)

(72) Inventor: Stefan Simkovics, San Diego, CA (US)

(21) Appl. No.: 18/956,061

(22) Filed: Nov. 22, 2024

Related U.S. Application Data
(62) Division of application No. 29/962,279, filed on Sep. 11, 2024, now Pat. No. D067028.
(60) Provisional application No. 63/603,824, filed on Nov. 29, 2023.

(51) Int. Cl. B60P 7/08

(52) U.S. Cl. CPC B60P 7/0823

(57) ABSTRACT

A securement strap system for securing recreational equipment to vehicles is disclosed. The system includes a securement strap with an elastic portion and an adjustable portion, allowing for versatile use with various equipment sizes. A T-shaped handle with a perpendicular hook is attached to one end of the strap, providing improved grip and maneuverability for users. The system may include anchor straps for additional securement options. Protective sleeves and pliable pads can be incorporated to prevent damage to equipment and vehicles. The system offers enhanced ease of use, adjustability, and protection compared to conventional straps, making it particularly suitable for securing sports equipment such as surfboards, kayaks, and bicycles to vehicle racks or truck beds.

### CROSS-REFERENCE TO RELATED APPLICATIONS

This application claims the priority and benefit of U.S. Prov. Pat. No. 63/603,824 (filed Nov. 29, 2023) for a “Strap Securement device.” See Application Data Sheet (ADS). This application is a Divisional of U.S. Des. patent application Ser. No. 29/962,279 (filed Nov. 5, 2024) for a “Handle and hook.” See ADS. Every one of these documents is hereby incorporated by reference in their entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

A technical specification for a product called RASANT/STRAPS was published on Feb. 10, 2024. The technical specification, also called a “tech pack” is incorporated by reference in its entirety.

### BACKGROUND OF THE INVENTION

### Field of Invention

The disclosed subject matter relates to securement devices for recreational equipment carried on vehicles. Specifically, it pertains to an adjustable strap system designed to secure various types of recreational gear, such as water sports equipment, to vehicle roof racks, truck beds, or bumper-engaged racks. The system features a unique combination of elastic and inelastic components, along with an easy-grip T-shaped handle for improved engagement and disengagement.

### Listing of the Prior Art

References cited in Information Disclosure Statements (IDSs) of record or in any related patent applications might be relevant to the subject matter of this disclosure. The following references from the IDS are specifically mentioned in this specification and incorporated by reference:
U.S. Pat. No. 2,346,264 (issued Apr. 11, 1944) by Dowe and U.S. Pat. No. 3,113,479 (issued Dec. 10, 1963) by Swingle disclose t-shaped tool handles;
U.S. Pat. No. 4,831,692 (issued May 23, 1989) by Chuan discloses a hook with a finger-hole that can be attached to at least one end of an elastic cord (see abstract);
U.S. Pat. No. 5,623,750 (issued Apr. 29, 1997) by Nasin et al. discloses an adjustable elastic and inelastic strap apparatus;
U.S. Pub. Pat. No. 2005/0050695 (published Mar. 10, 2005) and U.S. Des. Pat. No. D525,861 (issued Aug. 1, 2006) by Makey et al. disclose a bungee cord hook;
U.S. Pub. Pat. No. 2013/0232732 (published Sep. 12, 2013) by Jacobson et al. discloses a hook device with a finger loop that can be attached to an elastic cord (see abstract);
U.S. Pub Pat. No. 2016/0066658 (published Mar. 10, 2016) by Breen et al. discloses a cord fixture with a hook and finger-hole (see para. [0054]);
U.S. Pub. Pat. No. 2021/0284426 (published Sep. 16, 2021) by Kalajyan et al. discloses a cooler with a lid that has a latch mechanism (element 703, FIG. 16);
U.S. Des. Pat. No. D23,802 (issued Nov. 13, 1894) discloses the design of a harness hook;
U.S. Des. Pat. No. D468993 (issued Jan. 21, 2003) by Votruba et al. discloses the design of a hook;
U.S. Des. Pat. No. D557,591 (issued Dec. 18, 2007) by Mackey discloses the design of a hook;
U.S. Des. Pat. No. D604,592 (issued Nov. 24, 2009) by Given discloses the design of a cord hook;
U.S. Des. Pat. No. D649,024 (issued Nov. 22, 2011) by Takazakrua discloses the design of a swivel hook’;
U.S. Des. Pat. No. D659,516 (issued May 15, 2012) by Schoen et al discloses the design of an elastic tie down device;
U.S. Des. Pat. No. D661, 175 (issued Jun. 5, 2012) by Dahl et al. discloses the design of a rope assembly;
U.S. Des. Pat. No. D694,096 (issued Nov. 26, 2013) by DeFrancisci discloses the design of a hook;
U.S. Des. Pat. No. 707,536 (issued Jun. 24, 2014) by Van Riper discloses the design of a covered tarp strap;
U.S. Des. Pat. Nos. D712,720 & D712,722 by Seiders (issued Sep. 9, 2014) disclose the design of a latch;
U.S. Des. Pat. No. D801,788 (issued Nov. 7, 2017) by Dershem discloses the design of a bungee cord hook;
U.S. Des. Pat. No. D953, 149 (issued May 31, 2022) by Ormsbee discloses the design of a locking bungee;
U.S. Des. Pat. No. D1,012,676 (issued Jan. 30, 2024) by Wang discloses the design of an adjustable elastic binding rope;

### Background of the Invention

Modern recreational sports, such as surfing, paddle boarding, kayaking, skiing, canoeing, hiking and the like are widely enjoyed around the world. Sports enthusiasts for such recreational activities, however, must transport their recreational gear to the site where they intend to use it. For example, and in no way limiting, surfboards are conventionally ridden at beaches where there is wave action to allow surfers to ride surfboards upon the incoming waves, and mountain bikes are frequently transported to mountain trails where they can be ridden.

Conventionally, where the sports equipment is secured in the bed of a truck, such sports equipment transport has evolved to employ roof-mounted racks and bumper-engaged racks operatively positioned upon a vehicle. To transport their recreational gear, such as a surfboard or water craft or the like, users secure them to the roof rack in a manner where high winds encountered during high speed driving will not dismount them. Such has evolved over the years from simple ropes to strap systems adapted to the individual rack on which they are mounted.

In many instances, such roof racks and strap systems are hard to use and can be less than secure where the straps used are not properly engaged around both the recreational gear and to the racks. Proper engagement is frequently hindered by the very design of the securement straps and the attaching hardware. With respect to the above, before explaining at least one preferred embodiment of the securement strap system herein, it is to be understood that the disclosed securement strap device and system herein is not limited in its application to the details of employment and to any arrangement of components or steps set forth for use in the following description or illustrated in the drawings. The various strap apparatus and components and configurations and methods of employment thereof, as herein disclosed, are capable of other embodiments and of being practiced and carried out in various ways, all of which will be obvious to those skilled in the art subsequent to their review of this specification.

For instance, in addition to recreational sports equipment, the securement strap system herein is also critically important for emergency and lifesaving applications. First responders, such as lifeguards and emergency rescue teams, require rapid and reliable access to their equipment in time-sensitive situations. Traditional strap systems used for securing rescue boards and other lifesaving tools to vehicles or storage racks often lack the speed, reliability, and ergonomic functionality necessary in high-pressure emergency scenarios

The securement strap system disclosed herein addresses these critical deficiencies in the field of emergency response, particularly in ocean rescue operations. By providing a novel strap design tailored specifically to the needs of first responders, this invention enables swift and consistent release of rescue boards and other vital lifesaving equipment. The system's unique features, including the T-shaped handle and perpendicular hook configuration, allow for rapid deployment under pressure, potentially saving crucial seconds in emergency situations

This specialized strap system enhances the operational readiness of first responders during rescue scenarios by prioritizing quick access and deployment under emergency conditions. By offering a streamlined, efficient, and reliable solution for securing and rapidly releasing equipment, the invention improves the overall efficiency and effectiveness of rescue operations. This advancement in securement technology has the potential to significantly impact the success rate of lifesaving efforts, making it an invaluable tool for lifeguards and other emergency personnel who rely on immediate access to their equipment in critical situations.

Also, it is to be understood that the phraseology and terminology employed herein are for the purpose of description for an understanding of the use and operation of the securement strap system herein and should not be regarded as limiting. As such, those skilled in the art will appreciate that the conception upon which this disclosure is based may readily be utilized as a basis for other strap systems adapted for use to secure recreational gear to vehicles. It is important, therefore, that the embodiments, objects and claims herein, be regarded as including such equivalent construction and methodology insofar as they do not depart from the spirit and scope of the present invention.

### SUMMARY OF THE INVENTION

The disclosed invention relates to a securement device specifically engineered for rapid deployment of lifesaving equipment. More particularly, the invention pertains to an adjustable strap system optimized for the swift and consistent release of rescue boards and other critical lifesaving tools used by first responders, such as lifeguards and emergency rescue teams. Current strap designs often lack the speed, reliability, and ergonomic functionality necessary in time-sensitive emergency scenarios, thereby hindering rescue efforts. The present invention addresses these deficiencies, enabling first responders to perform lifesaving tasks with greater efficiency and consistency under high-pressure conditions.

In the field of emergency response, particularly ocean rescue operations, the rapid deployment of lifesaving equipment is paramount to ensuring effective rescue outcomes. Conventional strap systems commonly used to secure rescue boards to vehicles or storage racks are cumbersome to operate and prone to inconsistency during deployment, often resulting in delays. This invention introduces a novel strap design tailored specifically to address these challenges, providing first responders with a secure yet easily operable mechanism that minimizes deployment time while maintaining equipment stability during transport.

The present invention is directed to a specialized strap system designed to enhance the operational readiness of first responders during rescue scenarios. Traditional securement devices for rescue boards and similar equipment lack features that prioritize rapid access and deployment under emergency conditions. These limitations can result in critical time delays, potentially endangering lives. The invention described herein provides a streamlined, efficient, and reliable solution, allowing for quick release and consistent performance, ultimately improving the efficiency and effectiveness of rescue operations for lifeguards and other first responders.

The securement strap system herein is adapted, in on embodiment, for use to secure recreational gear carried upon a vehicle, whether the gear is stowed in a truck bed or upon a roof rack or bike rack or the like. The strap system, being length-adjustable and imparting compression when secured, is employable to secure virtually any recreational gear to or on a vehicle. The strap system is especially well adapted to secure recreational gear on any vehicle-mounted rack or within a compartment, such as a truck bed.

In all modes of the strap system herein, it is preferred that the securement strap has an elastic portion. This elastic portion provides for adjustability of the final length of the securement strap to allow it to secure multiple different sized sports components. The elastic portion is also preferred to provide a compressive contact and engagement of the securement strap against the recreational equipment being carried. For narrower recreational equipment being secured, the elastic portion is stretched slightly, and for wider or taller loads, needing vehicle securement in addition to a buckle adjustment, the elastic portion may be stretched further to accommodate them. While the elastic portion herein is shown adjacent the second end of the strap and such is preferred to allow for easier stretching by the user, it can be positioned elsewhere.

Currently, a central area of the securement strap is formed of elastic material which will elongate and contract for months or years and continue to hold its shape and provide function. Such elastic material may be, for example, rubber rope or strapping or other polymeric material which is engageable to the non-elastic portions of the securement strap. Such engagement may be by sewing, adhesive, sonic welding, or other means of engagement which will secure the elastic material to the non-elastic portions of the securement strap.

While not required, to aid in protecting both the elastic material and contact thereof against the vehicle, rack or secured sports equipment, the securement strap herein positions the elastic portion with a fabric covering there around. This surrounding fabric covering has shown in experimentation to help protect the elastic material for degradation from U.V. light from the sun, as well as to provide a padding layer between the 10 elastic material and the vehicle or transported recreational equipment.

Also in a central area of the securement strap, engaged to and adjacent to the elastic portion, is a central strap portion which is preferred to provide for a strap length adjustment. This adjustment allows the securement strap to be employed with a wider variety of recreational and other equipment which can vary widely in dimension. For example, a kayak can be many times wider than a surfboard, and a bicycle can require a totally different securement than a roof-mounted load. The ability to adjust the overall length of the securement strap allows the strap herein to be employed with a much more diverse group of vehicle carried recreational equipment.

A current preferred strap length adjustment is provided by a releasable buckle through which a slack or adjustment portion of the non-elastic strap material is adjustably routed. Currently, the excess strap or slack portion of the strap is routed in a U-shaped path through the buckle and positioned against an adjacent portion of the strap holding the equipment. The aggregate length of the central strap portion is thus adjusted by pulling more or less of the slack portion through the U-shaped path, and then securing the buckle to hold the slack portion in position and removably fix the overall length of the strap. A removable buckle cover is also provided and is preferred in order to pad any contact of the buckle against the sports equipment or the vehicle.

Also preferred in the strap system herein is a sleeve which is configured to cover the adjustable slack portion of the strap material. This is most preferred to prevent the slack portion of the strap from flapping and moving during vehicle movement. Without the sleeve surrounding the adjustable slack portion of the strap, it would tend to fly about and strike the vehicle and/or the carried recreational equipment during transport. Such a whipping motion is known to cause damage to surrounding surfaces as well as fraying the slack portion itself. As such, while the strap will function without it, the sleeve covering it is preferred.

At a first end of the securement strap is positioned a first strap portion on which an engagement component is positioned. Currently, a first loop is formed at the first end of the overall strap which is formed of the strap material. Currently, this first loop is formed by securing the distal end of the strap material of the first portion of the strap to the adjacent strap material forming the first portion of the strap. This securement may be by sewing, sonic welding, rivets, grommets or other such fasteners or other means for engagement. However, it is envisioned that other fasteners and configurations might be employable for securement of the first end of the strap and such is anticipated as being included herein. A second end of this first portion of the strap is connected to or formed as part of the central area of the securement strap.

The substantially non-elastic material currently preferred for the securement strap is a narrow woven fabric, such as that used for auto seat belts and securement straps and the like. Preferably, the yarn forming the strap is formed of polyester or U.V. inhibited nylon. However, any natural or synthetic fabric which will provide the strength required for securing and holding the sports equipment during vehicle movement and transport would be acceptable.

At the second end of the securement strap, engaged to or adjacent to a second end of the elastic material and any covering surrounding it, is an engagement hook having a T-shaped handle. In all modes of the securement strap herein, this T-shaped handle is preferred. This is because the handle with this configuration allows for the user to easily grip it and easily pull upon it and the engaged strap to elongate the elastic portion thereof. This handle shape has also shown in experimentation to provide a significant visual and mechanical advantage to the user when trying to secure the hook portion and to detach the hook portion from the rack to which the securement strap engages.

The T-shaped handle and hook design include: a T-shaped appearance consisting of a one-eyed shank intersected about the bend of the hook by a crossbar forming arms; where the arms extend perpendicular to the hooks barb with an acute angle relative to the shank thereby creating multilateral and cascading effects to enhance the handle and hook design's visual appeal; where the hook's barb extends from approximately the intersection of the shank and crossbar; and where the barb features a cascading topside that terminates at the barb's point and a multilateral bend on the underside that forms the a distinct multilateral appearance for the barbs bite or throat and gape. The utility of the T-shaped handle allows for quick release when needed, enhancing both the securing and releasing processes.

Conventional securement straps, whether they are provided as part of a roof rack or as a supplement thereto, often employ simple connectors or hooks to secure the distal end of the strap to a mount or the roof rack. For example, U.S. Pat. No. 5,623,750 by Nasin et al. discloses an adjustable elastic and inelastic strap apparatus with basic connectors or S hooks at each end. However, such designs typically require users to manipulate small connectors with their fingers, which can be difficult and time-consuming. The user must use their fingers to hold and pull on the connector while trying to guide it to a secure connection. As can be discerned, a compressed engagement of the finger and thumb of a user on such a connector allows for minimal force to be applied to stretch a strap, as the connector will easily dismount. Further, while the user is in this compressed grip of the connector, they must find a small mounting area and try to steer or move the connector to engage it. This is not an easily accomplished task, especially in adverse weather conditions or when dealing with heavy or awkwardly shaped recreational equipment. In critical rescue situations, such delays in securing or deploying equipment can hinder first responders, impeding their ability to act swiftly and efficiently. These shortcomings underscore the need for a securement system that ensures rapid, consistent, and reliable deployment of lifesaving tools in emergency scenarios.

The T-shaped handle herein is operatively connected to a hook portion. This hook portion preferably extends in a plane that is substantially perpendicular to the axis of the handle which is gripped by the full hand of the user. This configuration makes it easy for the user to pull upon the handle using all their fingers and thumb wrapped there around while concurrently stretching the elastic portion of the strap. The secure hold allows for much more force to be exerted by the user and allows them to use their entire hand to twist or otherwise locate the hook to a mount or to dismount it. In experimentation, this configuration of handle and hook has shown to provide a significant enhancement to the speed which a user may engage and disengage the strap from the recreational equipment it holds. For example, where a lifeguard must detach the strap holding lifesaving water gear where seconds count, the strap system herein, with the handle and hook configuration noted, speeds up that process considerably, enabling first responders to save lives faster.

For use with roof racks and other vehicle racks, which are not well adapted for engagement of the first loop at the first end of the securement strap or where a very tall load of recreational equipment is being carried, the strap system herein provides anchor straps for enhancing overall length and securement. These anchor straps are formed preferably of the same non elastic strap material and have a second loop formed at a first end thereof. This second loop may be positioned around a mount, such as the end of a roof rack. At the opposite end of the anchor strap, an engagement point for the hook is positioned, such as a D-ring fastener or a grommet or similar fastener having a central passage therethrough. The opening on such a fastener provides an engagement point for the hook located on the handle of the securement strap, noted above.

In a particularly preferred mode of the securement strap herein, there is also provided pliable pads which may be slidably engaged upon different areas of the securement strap as needed. These pliable pads are formed of a durable polymeric or rubber or plastic material so as to provide a pad when they are positioned on the securement strap to pad the rack or the sports equipment from strap contact. The sliding engagement allows the strap to move while the pad is stationary, such as when in contact with the sports equipment. This provides a better gripping contact of the strap to the sports equipment while concurrently protecting it from friction or other damage the strap contact might cause.

With respect to the above summary description, before explaining at least one preferred embodiment of the securement strap system herein, it is to be understood that the invention is not limited in its application to the details of operation nor the arrangement of the components or the steps set forth in the following description or illustrations in the drawings. The various methods of implementation and operation of the securement strap herein are capable of other embodiments and of being practiced and carried out in various ways which will be obvious to those skilled in the art upon their review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis by others for designing of other modes for carrying out the several purposes of the present securement strap system. Therefore, the objects and claims herein should be regarded as including such equivalent construction, steps, and methodology insofar as they do not depart from the spirit and scope of the present invention.

As used in the claims to describe the various inventive aspects and embodiments, “comprising” means including, but not limited to, whatever follows the word “comprising.” Thus, use of the term “comprising” indicates that the listed elements are required or mandatory, but that other elements are optional and may or may not be present. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Where used herein, if not otherwise defined, the term “substantially” means plus or minus five percent.

It is an object of this invention to provide a securement strap which includes a handle and hook which are easily gripped and manipulated by the hand of the user.

It is a further object of this invention to provide such a securement strap which has an elastic portion and has an adjustable portion so as to be employable to secure a wide variety of recreational equipment to vehicles.

These together with other objects and advantages, which become subsequently apparent, reside in the details of the construction and operation of the disclosed securement strap system herein as more fully hereinafter described and claimed, reference being had to the accompanying drawings forming a part thereof, wherein like numerals refer to like parts throughout. Further objectives of this invention may be ascertained by those skilled in the art as brought out in the following part of the specification wherein detailed description is for the purpose of fully disclosing the invention without placing any limitations thereon.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached FIG.s. The accompanying drawings, which are incorporated herein and form a part of the specification, illustrate some but not the only or exclusive examples of embodiments and/or features of the disclosed securement strap herein. It is intended that the embodiments and FIG.s disclosed herein are to be considered illustrative of the invention herein, rather than limiting in any fashion.

In the drawings:

FIG. 1 shows an overhead view of a securement strap system having easy grip handles, such as T-shaped handles with hooks, and an optional anchor strap having ring mounts on one end and second loops formed on the other.

FIG. 1A shows an exploded view of the securement strap system of FIG. 1.

FIG. 2 depicts a conventional prior art strap securing system where a small S hook must be manipulated to stretch the strap and to engage within a loop or mount.

FIG. 3 depicts the securement strap herein in an engaged positioning of the hook thereon to the first end of an anchor strap having the loop thereof connected to a roof rack where the system is in contact with sports equipment (e.g., a surf board).

FIG. 3A shows the securement strap herein employed without the anchor straps wherein the hook positioned on the T-shaped handle is engaged on a mount, such as on a conventional roof rack.

FIG. 3B shows the securement strap herein employed without the anchor straps wherein the hook positioned on the T-shaped handle is engaged on another mount, such as hook, nook or eyelet (including aftermarket, welded-on eyelets) of a conventional roof rack.

FIG. 3C shows a securement straps with a loop secured around a conventional roof rack and also shows the optional pliable pads slidably positioned between sporting equipment and a buckle of the system. FIG. 3C further shows the buckle of the strap herein which is employable with the buckle employed upon the central strap portion to elongate or shorten the strap.

FIG. 4 shows an enlarged view of the T-shaped handle having a hook positioned substantially perpendicular thereon.

FIG. 4A shows a perspective view of the T-shaped handle.

FIG. 4B shows another perspective view of the T-shaped handle.

FIG. 4C shows a back view of the T-shaped handle.

FIG. 4D shows a side view of the T-shaped handle.

FIG. 4E shows a front view of the T-shaped handle.

FIG. 4F shows another side view of the T-shaped handle.

FIG. 5 is a perspective view of the anchor strap.

FIG. 5A is a side view of the anchor strap.

FIG. 5B is a loop of the anchor strap.

FIG. 6 depicts an elastic portion of the securement strap which is engaged on one side to the central strap portion and on an opposite side to the T shaped handle and hook and also shows, in dotted line, the elastic material positioned within a surrounding covering which is formed of strap material.

FIG. 6A is an illustrative view of an elongated elastic material within the surrounding covering.

FIG. 6B is an illustrative view of a contracted elastic material within the surrounding covering.

FIG. 7 depicts protective sleeves positioned to cover the slack portion of the strap extending from the buckle which is folded and inserted therein by the user during adjustment.

FIG. 8 shows the central portion of the strap showing the buckle length adjuster having an adjustment portion or slack portion of the strap extending therefrom which may be folded and covered by the protective sleeves of FIG. 7.

FIG. 9 depicts an alternative embodiment of the strap system that includes an enlarged protective sleeve.

FIG. 9A is a see-through view of the protective sleeve of FIG. 9.

FIG. 9B is a perspective view of the protective sleeve of FIG. 9.

FIG. 10 shows an overhead view of two securement straps having easy grip handles, such as T-shaped handles with hooks, and shows two optional anchor straps having ring mounts on one end and second loops formed on the other and also shows the optional pliable pads slidably positioned upon the strap and buckle covers.

FIG. 11 depicts the securement strap herein in an engaged positioning of the hook thereon to the first end of an anchor strap having the loop thereof connected to a roof rack and also shows the pliable pad slidably engaged on the anchor strap and in contact with the sports equipment.

FIG. 11A shows the securement strap herein employed without the anchor straps wherein the hook positioned on the T-shaped handle is engaged on a mount, such as on a conventional roof rack.

FIG. 12 shows an enlarged view of the T-shaped handle having a hook positioned substantially perpendicular thereon.

FIG. 13 shows the buckle of the strap herein which is employable with the buckle employed upon the central strap portion to elongate or shorten the strap and shows an optional buckle cover.

FIG. 14 is a perspective view of the anchor strap of FIG. 10.

FIG. 14A is a side view of the anchor strap of FIG. 10.

FIG. 15 depicts an elastic portion of the securement strap which is engaged on one side to the central strap portion and on an opposite side to the T shaped handle and hook and also shows, in dotted line, the elastic material positioned within a surrounding covering which is formed of strap material.

FIG. 16 is a view of a protective cover for the anchor strap of FIG. 10.

FIG. 17 depicts the protective sleeve positioned to cover the slack portion of the strap extending from the buckle which is folded and inserted therein by the user during adjustment.

FIG. 18 shows the central portion of the strap showing the buckle length adjuster having an adjustment portion or slack portion of the strap extending therefrom which may be folded and covered by the protective sleeves of FIG. 17.

FIG. 19 shows an enlarged view of another embodiment of the T-shaped handle having a hook positioned substantially perpendicular thereon.

FIG. 19A shows a perspective view of the T-shaped handle.

FIG. 19B shows another perspective view of the T-shaped handle.

FIG. 19C shows a back view of the T-shaped handle.

FIG. 19D shows a side view of the T-shaped handle.

FIG. 19E shows a front view of the T-shaped handle.

FIG. 19F shows another side view of the T-shaped handle.

FIG. 20 shows an enlarged view of another embodiment of the T-shaped handle having a hook positioned substantially perpendicular thereon.

FIG. 20A shows a perspective view of the T-shaped handle.

FIG. 20B shows another perspective view of the T-shaped handle.

FIG. 20C shows a back view of the T-shaped handle.

FIG. 20D shows a side view of the T-shaped handle.

FIG. 20E shows a front view of the T-shaped handle.

FIG. 20F shows another side view of the T-shaped handle.

FIG. 21 shows an enlarged view of another embodiment of the T-shaped handle having a hook positioned substantially perpendicular thereon.

FIG. 21A shows a side view of the T-shaped handle.

FIG. 21B shows another perspective view of the T-shaped handle.

FIG. 21C shows an X-ray view of the T-shaped handle.

FIG. 21D shows an X-ray side view of the T-shaped handle.

FIG. 21E shows an X-ray perspective view of the T-shaped handle.

FIG. 21F shows an engineering view of the T-shaped handle.

FIG. 21G shows an engineering back view of the T-shaped handle.

FIG. 21H shows a bottom perspective view of the T-shaped handle.

FIG. 21I shows a top perspective of the T-shaped handle.

FIG. 21J shows a skeleton of the T-shaped handle.

FIG. 21K shows a side view of the skeleton.

FIG. 21L shows a perspective view of skeleton.

FIG. 21M shows a perspective view of the skeleton.

It is to be noted, however, that the appended FIG.s illustrate only typical embodiments of this invention and are therefore not to be considered limiting of its scope, for the invention may admit to other equally effective embodiments that will be appreciated by those reasonably skilled in the relevant arts. Also, FIG.s are not necessarily made to scale but are representative.

### DETAILED DESCRIPTION OF PREFERRED EMBODIMENTS

In this description, the directional prepositions of up, upwardly, down, downwardly, front, back, top, upper, bottom, lower, left, right, first, second, and other such terms refer to the securement strap and components thereof as they are oriented and appear in the drawings and all such terms are used for convenience only and such are not intended to be limiting or to imply that the securement strap has to be used or positioned in any particular orientation.

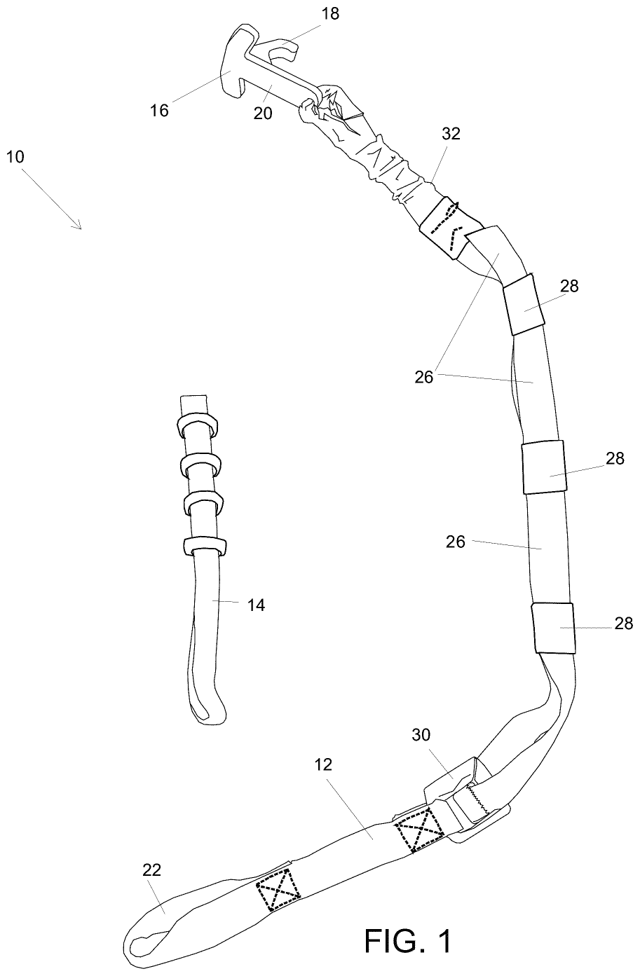

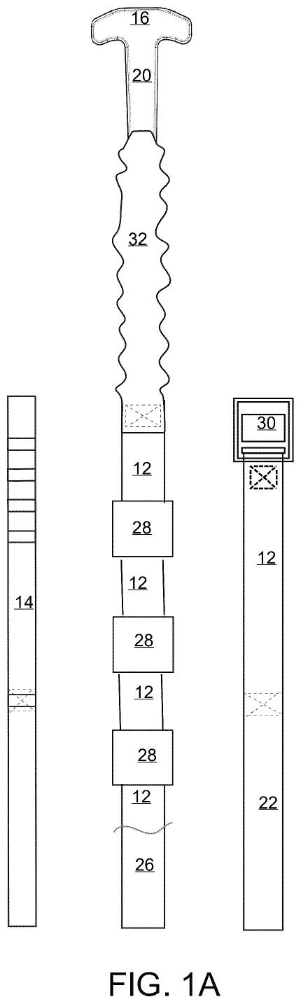

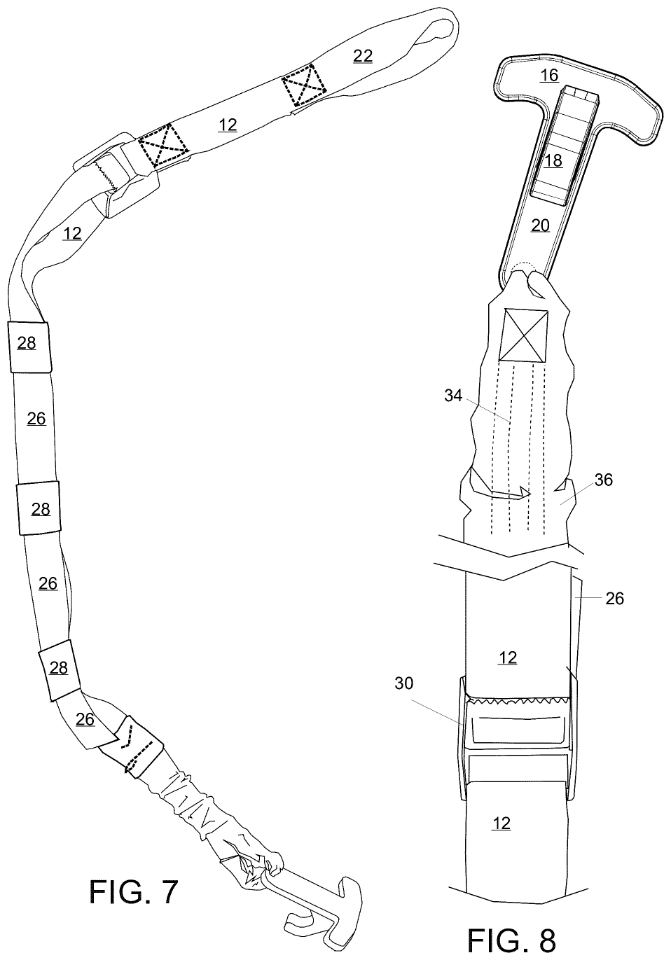

Now referring to drawings in FIGS. 1-8, there is seen in FIG. 1 a view of the securement system 10 as it may be provided as a kit of at least one securement strap 12 and at least one anchor strap 14. While the anchor strap 14 may not be required, it provides a user with additional options as to the dimension of the recreational equipment being carried which may be secured. At a minimum the system 10 will include at least one securement strap 12. In other methods of use, the system 10 will include a pair of securement straps 12 and/or anchor straps 14.

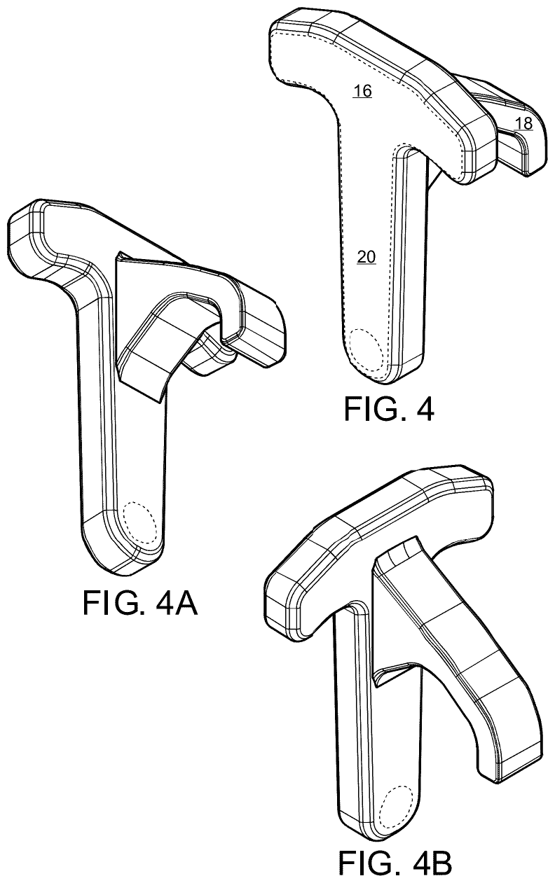

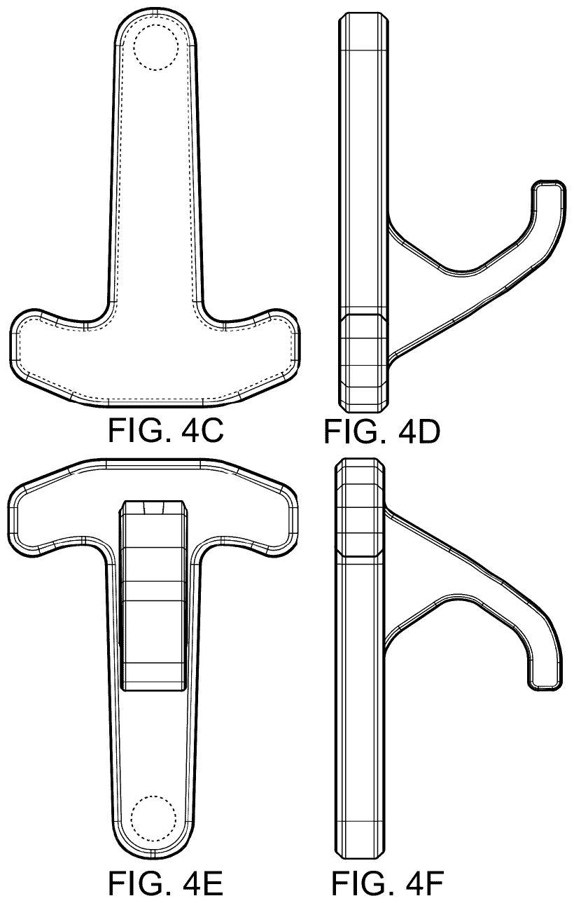

Shown in FIG. 1 and FIGS. 4 through 4F is the handle 16 which is configured for an easy grip by the user in a manner where they can wrap their fingers and thumb there around for a secure grip. Currently, the handle 16 is preferably formed in substantially a T-shape which allows users to wrap their fingers and thumb there around. The configuration as a T shape is also preferred as it allows the positioning of a hook 18 in a substantially perpendicular mount to the body 20 and the handle portion 16. This positioning provides the user with a good view of the distal end of the hook 18 while they are manipulating it to a mount. The handle 16, as shown, is engaged to the second end of the strap 12. As shown, the second end of the securement strap 12 is engaged through an opening in the handle body 20 and sewn or riveted or otherwise secured back onto the strap body.

As shown in FIGS. 4 through 4F, the T-shaped handle 16 and hook 18 design include: a T-shaped appearance consisting of a one-eyed shank or body 20 intersected about the bend of the hook 18 by a crossbar or handle 16 forming arms; where the arms extend perpendicular to the hooks barb with an acute angle relative to the shank thereby creating multilateral and cascading effects to enhance the handle 16 and hook 18 design's visual appeal; where the hook's 18 barb extends from approximately the intersection of the shank or body 20 and crossbar or handle 16; and where the barb features a cascading topside that terminates at the barb's point and a multilateral bend on the underside that forms the a distinct multilateral appearance for the barbs bite or throat and gape.

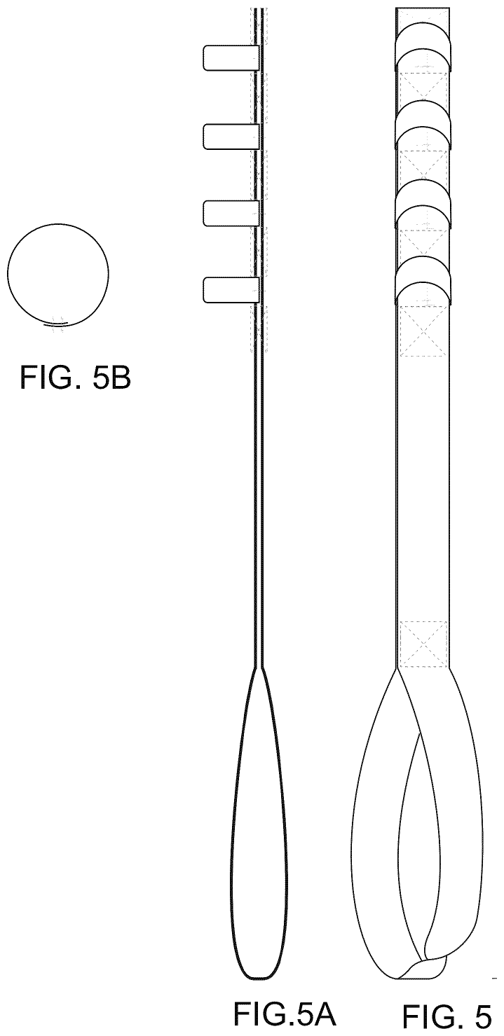

FIGS. 5 through 5B show the anchor strap 14. As shown, the anchor strap 14 may suitably be one inch wide, dual layer of flat strap with loops that have a 3″ circumference and box stitching sewn in between the layers to prevent the loop from sliding up and down the length of the strap 14. In some cases, the loops have bar tack stitching to prevent the loops from rotating around the strap 14. Suitably, the loops are 0.5″ wide and are spaced by 1″ relative to one another along the length of the anchor strap 14. The loop on the end features a 180 degree twist for ease of use and for a flatter configuration when laid down on a surface and during periods of non-use. Suitably, the loop portion may be 6″ long and the remainder of the strap 14 may be 13″ long.

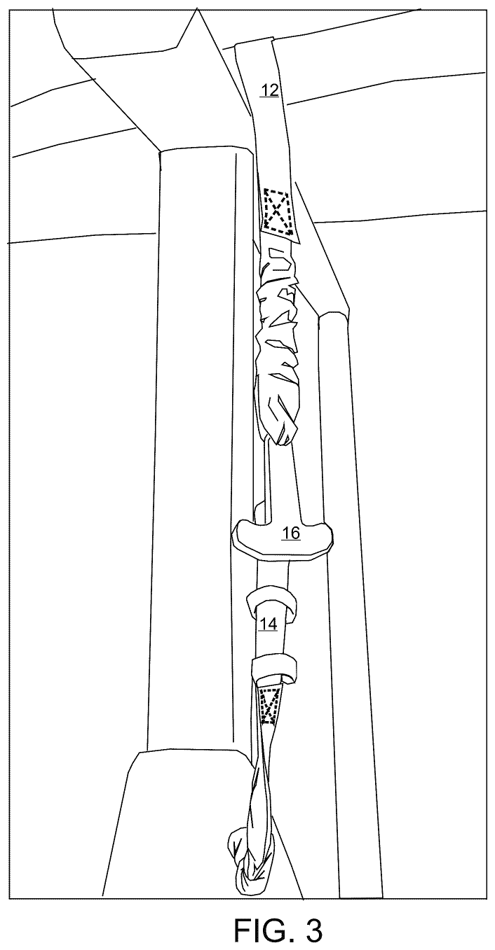

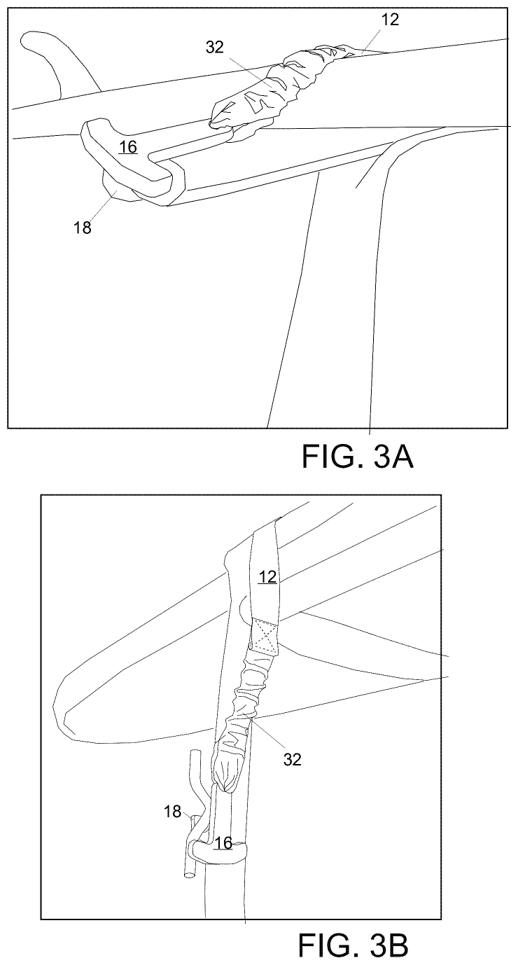

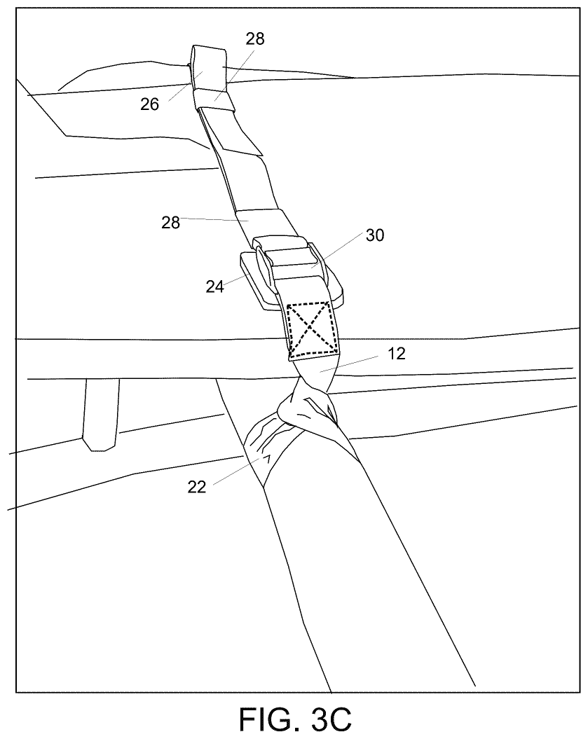

At a first end of the securement strap 12 in FIG. 1 is depicted a first loop 22 which is formed from strap material sewn back on itself. The first loop 22 is employable by the user to secure the first portion of the strap to a fixed mount on the vehicle or upon a rack engaged to the vehicle such as by pulling the handle and strap therethrough to form a cinched engagement (see, e.g., FIG. 3C). Of course, a fastener might be positioned at this first end for securement and such is anticipated. The first loop 22 provides a very secure engagement without the worry of a fastener rubbing the vehicle or load.

Also shown in FIG. 3C is a pliable pad 24 formed with a passage therethrough. The securement strap 12 can be provided with one or more such pliable pads 24 which are in a sliding engagement with the securement strap 12 running through the passage of the pads 24. The pliable pads 24, as noted, may be positioned to contact the sports equipment or the vehicle where the securement strap 12 is engaged against the equipment or vehicle surface. This contact provides both padding to avoid friction and wear as well as a more secure engagement of the strap to the equipment from the pliable surface. It should be noted that the pliable pads 24 may also be provided for use on the anchor straps 14 or in a set where the user may slide them on as needed.

Referring to FIGS. 1, 1A and 3C, the buckle 30 is conventionally engaged to allow the strap material forming the securement strap 12 to form a U-shaped engagement therethrough where an extra slack portion of strap material can be pulled through the buckle 30 until the overall securement strap 12 is of the length desired. Thereafter, the buckle can be secured to hold that length. As shown in FIG. 1 and FIG. 7 and FIG. 8, the securement strap 12 has a length adjustment portion 26 which is shown extending from the buckle 30 in FIGS. 1, 7 and 8. This length adjustment portion 26 is currently situated in a central area of the securement strap 12. The buckle 30, as shown in FIG. 8, has a slack or length adjustment portion 26 of the securement strap 12 running therethrough.

By moving the length adjustment portion 26 through the buckle 30, a length of the first portion of the securement strap 12 from the first end to the buckle 30 can be adjusted by adding or subtracting a segment of the length adjustment portion 26. Once the strap length is adjusted to the desired length, the remaining slack portion of the length adjustment portion 26 still extending from the buckle 30, is preferably stowed within the one or more protective sleeves 28 as in FIGS. 1, 3C and 7.

The sleeves 28, as noted, are preferred, so they may be slid upon the slack portion of the length adjustment portion 26 of the strap exiting the buckle 30. This keeps the excess or slack strap material having no securement at a distal end thereof from impacting the carried equipment or the vehicle. Also, as shown later in FIG. 13, a buckle cover 31 may also be provided in a sliding engagement on the securement strap 12 to allow covering the buckle 30 as is shown in FIG. 1. This buckle cover 31 is preferred, as noted, to help pad any contact of the buckle 30 with the vehicle or the equipment being secured. As shown in FIG. 3C, a pad may be provided between the buckle 30 and sporting equipment (surfboard).

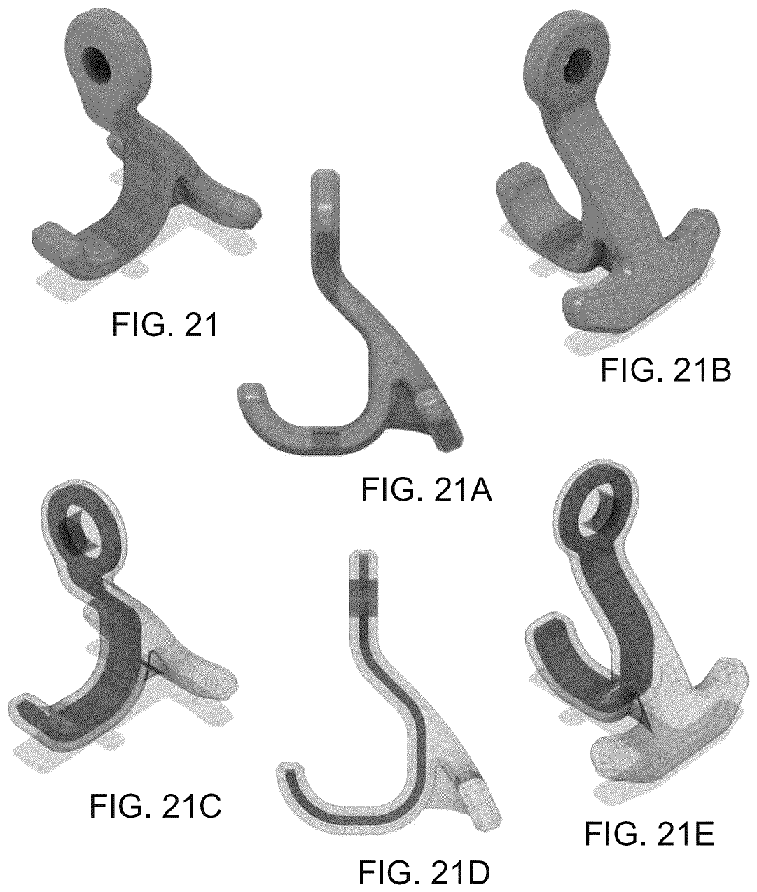

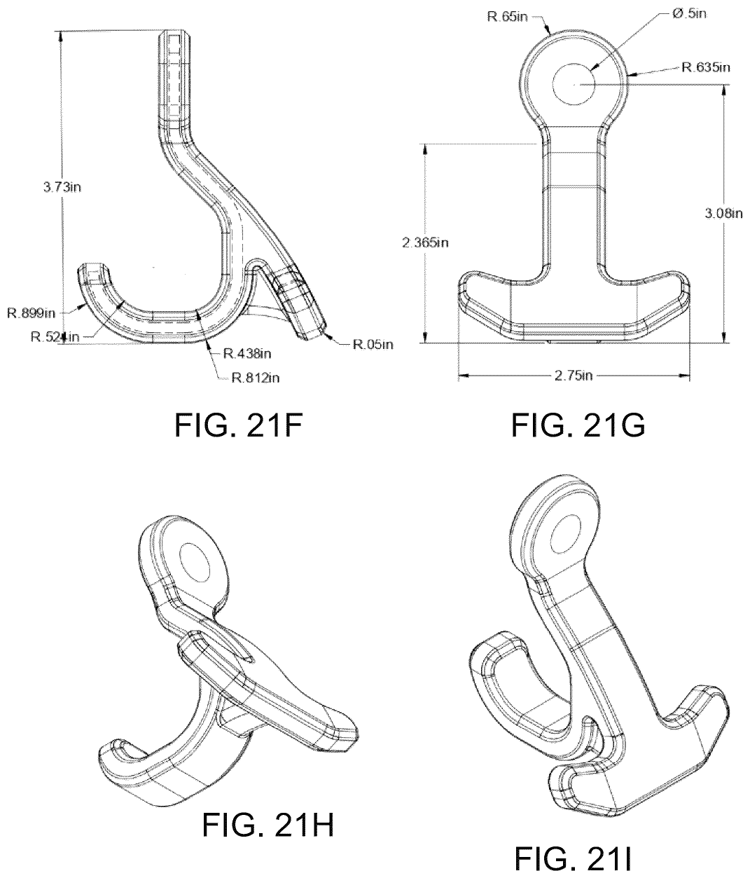

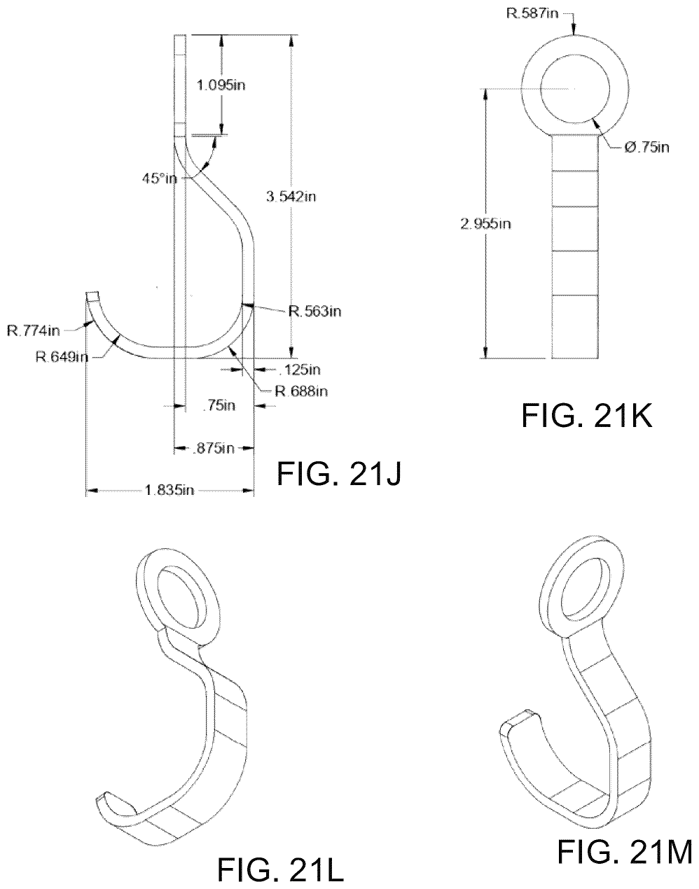

Those of skill in the art may know materials and structures for constructing a strap system in accordance with this disclosure. FIG. 1A shows an exploded view of a preferred embodiment of the strap depicted in FIG. 1 and may be useful for reference to materials of construction of one embodiment. As shown, the handle 16, body 20, and hook 18 (not shown) may be an EPDM molded Rubber handle with, in some embodiments, 0.1256′ stainless steel core or skeleton (not shown but see FIGS. 21 through 21M discussed later below). Suitably, the elastic portion 32 may be coupled to the body 20 and defined by a 1.5″ nylon tube webbing with, in many embodiments, a 50 lb.+/− bungee cord or other elastic element 34 (not shown) disposed therein. Additionally, the strap 12, loop, and adjustment portion 26 may be defined, in a preferred embodiments, by a 1.5″ nylon flat webbing and the sleeves 28 may be constructed of rubberized polymers. In one embodiment, the buckle 30 is a 1.5″ weather resistant cam buckle. In some embodiments, the anchor strap 14 may be constructed of a 1″ nylon flat webbing receiver with four, 0.5″ nylon flat webbing loops. Preferably, the strap 12 and its adjustment portion may be 60″ long.

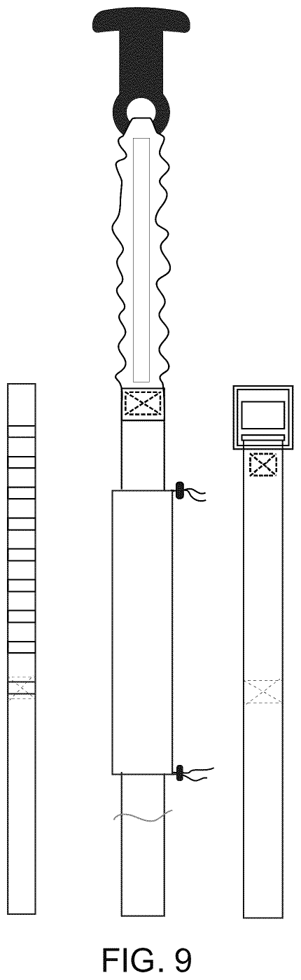

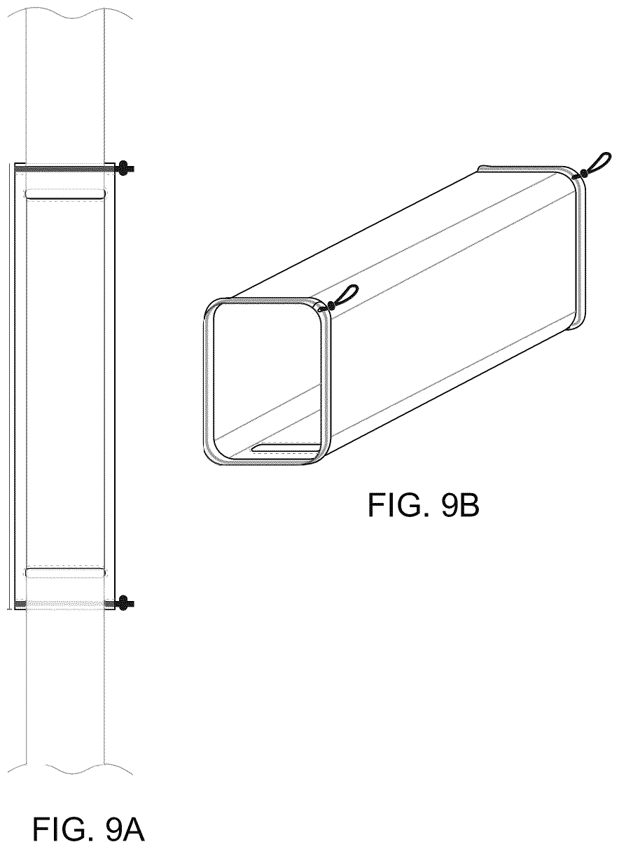

Referring now to FIGS. 9 through 9B, an alternative embodiment of the plurality of sleeves 28 depicted in, e.g., FIG. 1, may be an elongated, 8″ long sleeve as shown in FIGS. 9 through 9B. Suitably, the sleeve may be moved along the strap and a pull cord may be drawn to secure the sleeve in place. As shown in these FIGS, the embodiment of FIGS. 9 through 9B is similar to the embodiment of the earlier figures except that this embodiment features a single sleeve 28 with e.g. draw cinch openings for collecting the adjustment portion 26 of the strap 12 and the anchor strap 14 may suitably features additional loops for securing the hook portion 18 (not shown) of the system. It should be appreciated that any number of loops for the anchor strap 14 may be suitable for constructing the anchor strap 14 without departing from the spirit and intent of this disclosure. That said, four hoops on the anchor strap 14 are preferred such that the strap 14 and system can be relatively compact.

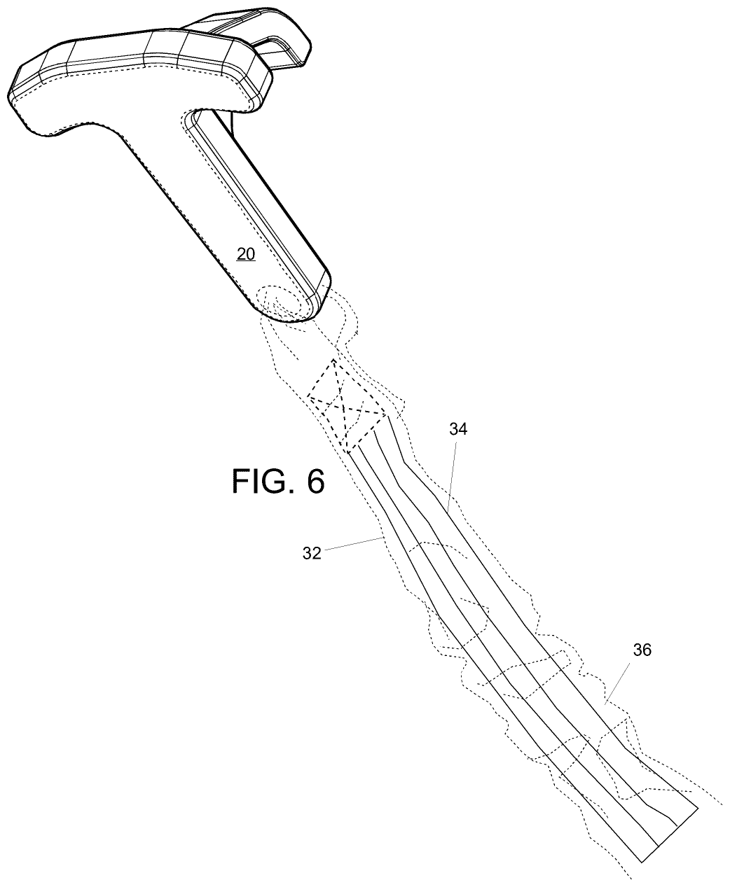

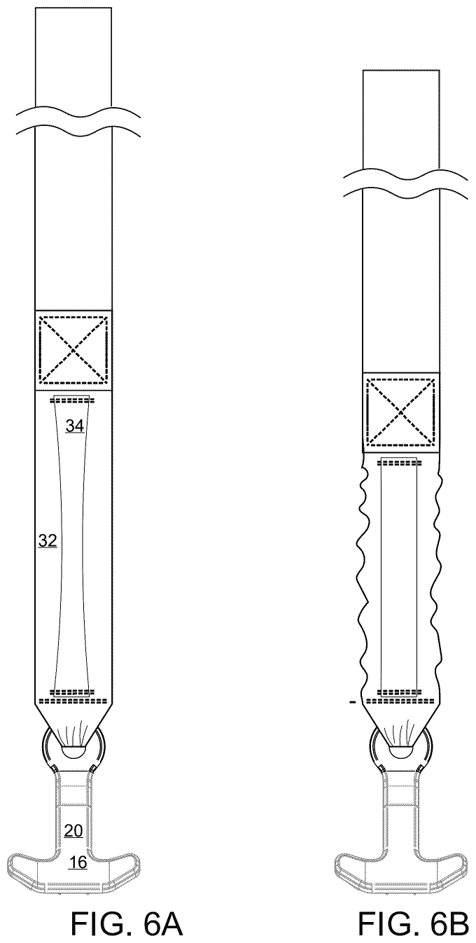

As noted, the securement strap 12 herein preferably has an elastic portion 32 which is best depicted in FIGS. 1 and 6. The elastic portion 32 has an elastic member 34 which is formed of material, such as rubber rope or an elastic polymer or plastic, such that, when stretched, it will impart a bias to the strap and handle 16 and engaged hook 18 in a direction opposite that in which it is stretched.

FIG. 6 through 6B illustrate operation of the elastic member 35 of the system. Currently, the elastic member 34 is positioned within the surrounding covering 36 as shown in FIG. 6. The covering 36 in the current favored mode of the system thus provides a covering to the elastic 34 which will expand and contract as needed. A passage running through the covering 36 allows for communication of the elastic member 34 between securement to the central portion of the securement strap 12 and to the hook 18 and handle 16. Thus, when the user pulls on the handle 20, it elongates the elastic member 34 as well as elongates the covering 36 surrounding it (see FIG. 6A). When the pull force is released, the elastic member 35 constricts to its baseline position (see FIG. 6B).

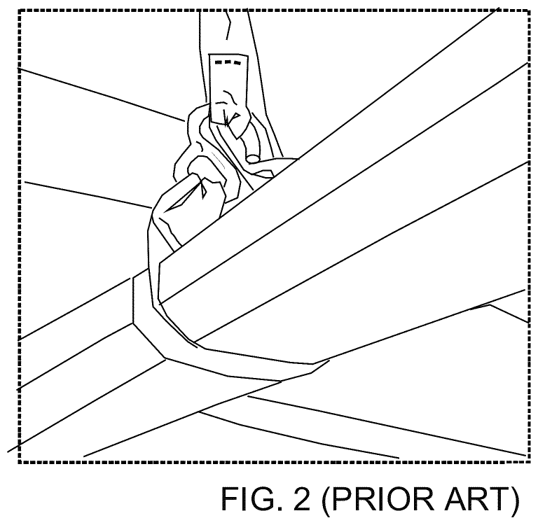

As noted, FIG. 2 shows a prior art depiction of a conventional securement strap as widely used. The S hook, as shown, must be held between the fingers and thumb while the strap is stretched and while engagement in a loop or on a hook is attempted. This hand action is awkward. The T-shaped handle and perpendicular hook configuration of the present invention provides significant advantages over prior art designs such as that disclosed in U.S. Pat. No. 5,623,750 by Nasin et al. While Nasin et al.'s apparatus includes both elastic and inelastic portions, it lacks the ergonomic and user-friendly features of the current invention. The T-shaped handle of the present invention allows for a full-hand grip, enabling the user to apply much greater force when stretching the elastic portion of the strap. This is in contrast to the simple connectors of Nasin et al., which are more difficult to manipulate and provide less leverage. Additionally, the perpendicular orientation of the hook relative to the handle in the current invention allows for better visibility and control when engaging or disengaging the hook from a mounting point. This configuration significantly enhances the ease of use and speed of operation, particularly in situations where quick attachment or detachment is crucial, such as in emergency scenarios or when dealing with time-sensitive recreational activities.

FIGS. 3 through 3C show the hook 18 engagement at the second end of the securement strap 12 herein. As shown in FIGS. 3 through 3C, using the handle 16, the user may easily pull and stretch the strap and concurrently engage the hook 18 into a ring or loop to an engagement point on the anchor strap 14, the vehicle or a rack or the like. A pliable pad 24 is shown slid to a position to contact the sports equipment, such as a surfboard, and insulate contact of the strap therewith. In a similar fashion in FIG. 3A, the user may easily pull, stretch the strap, and engage the hook 18 with a pin on the rack by pulling the handle 16 while having a clear view of the hook 18.

As shown in FIG. 3 and FIG. 5A through 5B the anchor strap 14 may have at least one loop upon to which the hook 18 may be attached. In some embodiments, the strap 14 has four loops to provide different graduations of tightness for the strap 12. In other embodiments (e.g., the embodiment of FIG. 9) the strap 14 has more than four loops.

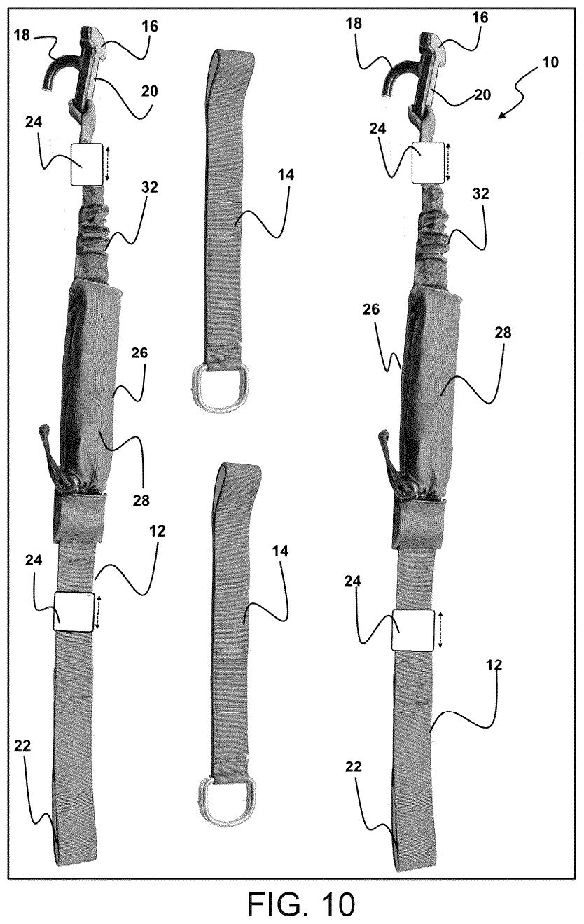

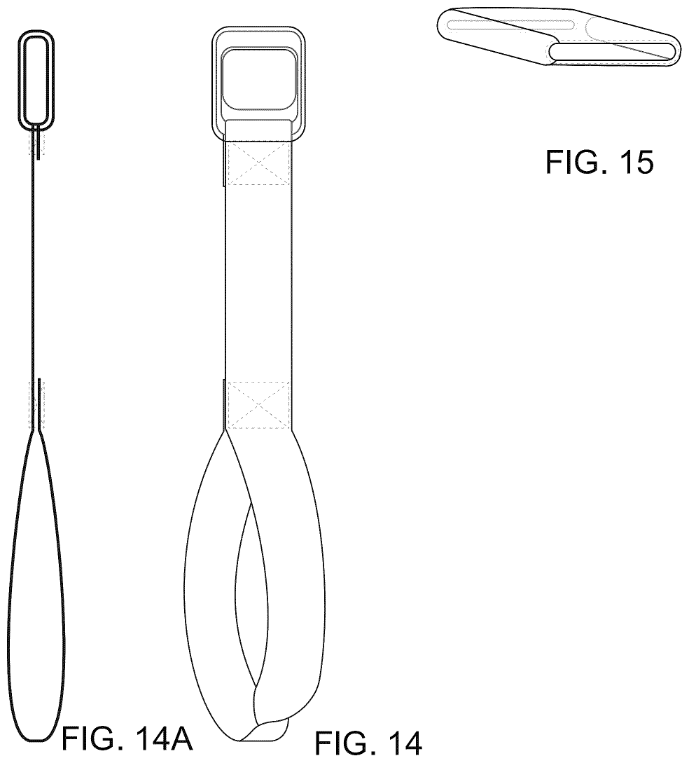

Now referring to drawings in FIGS. 10 through 18, there is seen in FIG. 10 a view of the securement system 10 as it may be provided as a kit of two securement straps 12 and two anchor straps 14. While the anchor straps 14 may not be required, they provide the user with additional options as to the dimension of the recreational equipment being carried which may be secured. At a minimum the system 10 will include at least one securement strap 12.

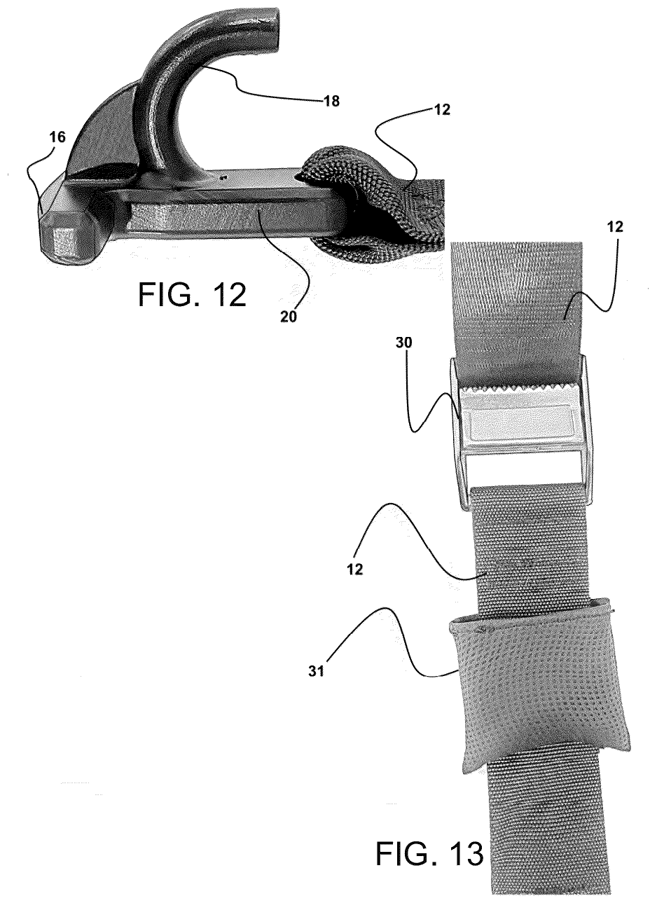

Shown in FIG. 10 and FIG. 12 is the handle 16 which is configured for an easy grip by the user in a manner where they can wrap their fingers and thumb there around for a secure grip. Currently, the handle 16 is preferably formed in substantially a T-shape which allows users to wrap their fingers and thumb there around. The configuration as a T shape is also preferred as it allows the positioning of a hook 18 in a substantially perpendicular mount to the body 20 and the handle portion 16. This positioning provides the user with a good view of the distal end of the hook 18 while they are manipulating it to a mount.

The handle 16, engaged to the hook, might also be D-ring shaped or of another shape adapted to allow the user to wrap their fingers and thumb around the handle 16 in an opposing grip to engage it. However, the T-shaped handle 16 and perpendicular hook 18 has been found to provide a much better view of the hook 18 to the user when they are trying to engage it to a mount or ring, and such is currently preferred.

The handle 16, as shown, is engaged to the second end of the strap 12. As shown, the second end of the securement strap 12 is engaged through an opening in the handle body 20 and sewn or riveted or otherwise secured back onto the strap body.

At a first end of the securement strap 12 in FIG. 10 is depicted a first loop 22 which is formed from strap material sewn back on itself. The first loop 22 is employable by the user to secure the first portion of the strap to a fixed mount on the vehicle or upon a rack engaged to the vehicle such as by pulling the handle and strap therethrough to form a cinched engagement. Of course, a fastener might be positioned at this first end for securement and such is anticipated. The first loop 22 provides a very secure engagement without the worry of a fastener rubbing the vehicle or load.

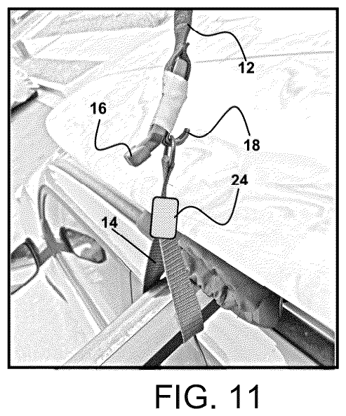

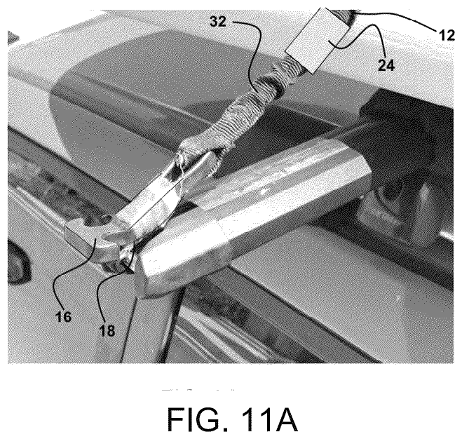

Also shown in FIG. 1 and FIG. 11 is a pliable pad 24 formed with a passage therethrough. The securement strap 12 can be provided with one or more such pliable pads 24 which are in a sliding engagement with the securement strap 12 running through the passage of the pads 24. The pliable pads 24, as noted, may be positioned to contact the sports equipment or the vehicle where the securement strap 12 is engaged against the equipment or vehicle surface. This contact provides both padding to avoid friction and wear as well as a more secure engagement of the strap to the equipment from the pliable surface. It should be noted that the pliable pads 24 may also be provided for use on the anchor straps 14 or in a set where the user may slide them on as needed.

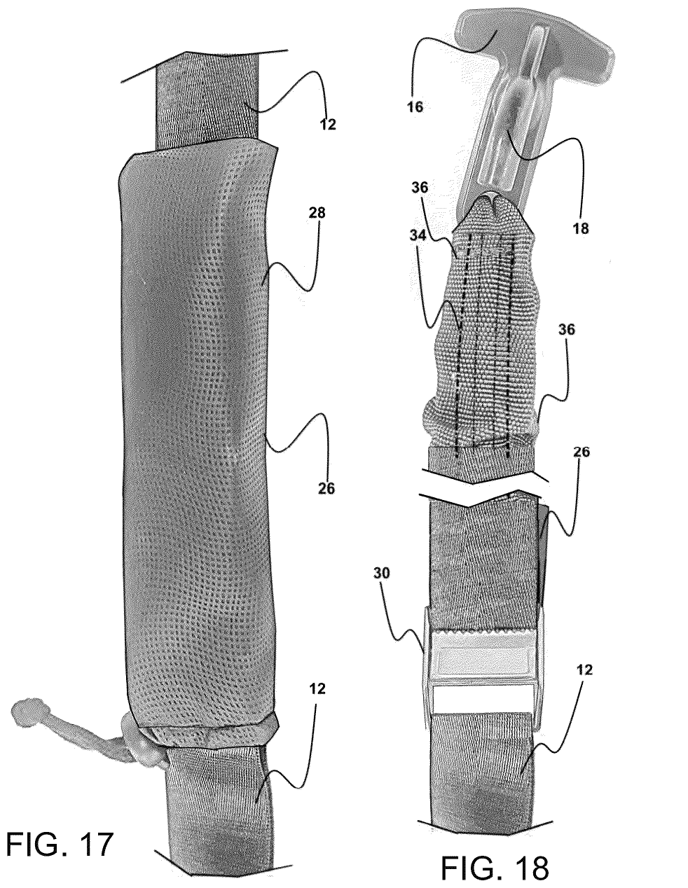

The buckle 30 is conventionally engaged to allow the strap material forming the securement strap 12 to form a U-shaped engagement therethrough where an extra slack portion of strap material can be pulled through the buckle 30 until the overall securement strap 12 is of the length desired. Thereafter, the buckle can be secured to hold that length. As shown in figure and FIG. 17 and FIG. 18, the securement strap 12 has a length adjustment portion 26 which is shown extending from the buckle 30 in FIG. 18. This length adjustment portion 26 is currently situated in a central area of the securement strap 12. The buckle 30, as shown in FIG. 18, has a slack or length adjustment portion 26 of the securement strap 12 running therethrough.

By moving the length adjustment portion 26 through the buckle 30, a length of the first portion of the securement strap 12 from the first end to the buckle 30 can be adjusted by adding or subtracting a segment of the length adjustment portion 26. Once the strap length is adjusted to the desired length, the remaining slack portion of the length adjustment portion 26 still extending from the buckle 30, is preferably stowed within the protective sleeve 28 as in FIGS. 10 and 17.

The sleeve 28, as noted, is preferred, so it may be slid upon the slack portion of the length adjustment portion 26 of the strap exiting the buckle 30. This keeps the excess or slack strap material having no securement at a distal end thereof from impacting the carried equipment or the vehicle. Also, as shown in FIG. 5, a buckle cover 31 may also be provided in a sliding engagement on the securement strap 12 to allow covering the buckle 30 as is shown in FIG. 10. This buckle cover 31 is preferred, as noted, to help pad any contact of the buckle 30 with the vehicle or the equipment being secured.

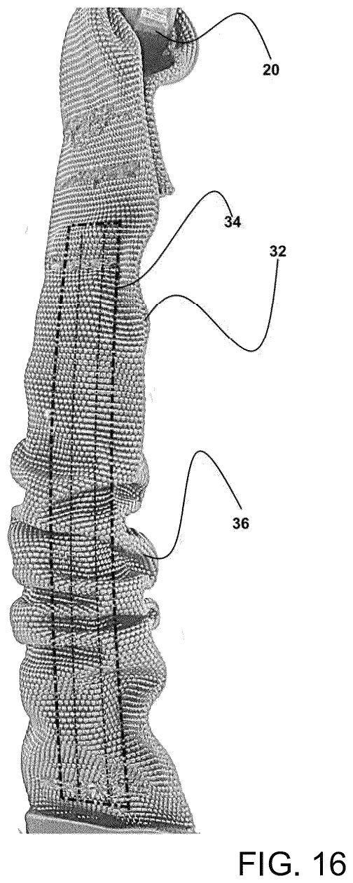

As noted, the securement strap 12 herein preferably has an elastic portion 32 which is best depicted in FIGS. 10 and 16. The elastic portion 32 has an elastic member 34 which is formed of material, such as rubber rope or an elastic polymer or plastic, such that, when stretched, it will impart a bias to the strap and handle 16 and engaged hook 18 in a direction opposite that in which it is stretched.

Currently, the elastic member 34 is positioned within the surrounding covering 36 as shown in FIG. 6. The covering 36 in the current favored mode of the system thus provides a covering to the elastic 34 which will expand and contract as needed. A passage running through the covering 36 allows for communication of the elastic member 34 between securement to the central portion of the securement strap 12 and to the hook 18 and handle 16. Thus, when the user pulls on the handle 20, it elongates the elastic member 34 as well as elongates the covering 36 surrounding it.

FIGS. 11 and 11A show the hook 18 engagement at the second end of the securement strap 12 herein. As shown in FIG. 11, using the handle 16, the user may easily pull and stretch the strap and concurrently engage the hook 18 into a ring or loop to an engagement point on the vehicle or a rack or the like. A pliable pad 24 is shown slid to a position to contact the sports equipment, such as a surfboard, and insulate contact of the strap therewith. In a similar fashion in FIG. 3A, the user may easily pull, stretch the strap, and engage the hook 18 with a pin on the rack by pulling the handle 16 while having a clear view of the hook 18.

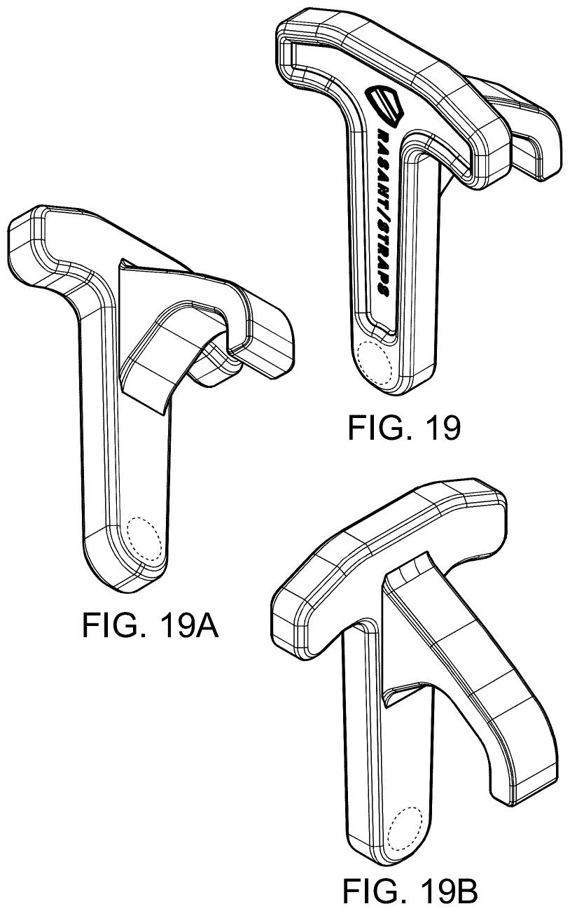

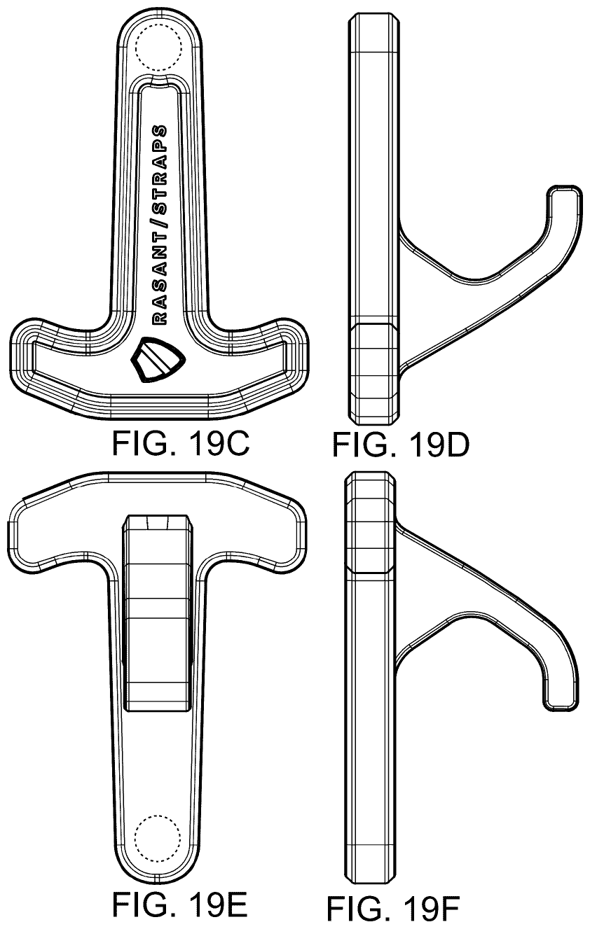

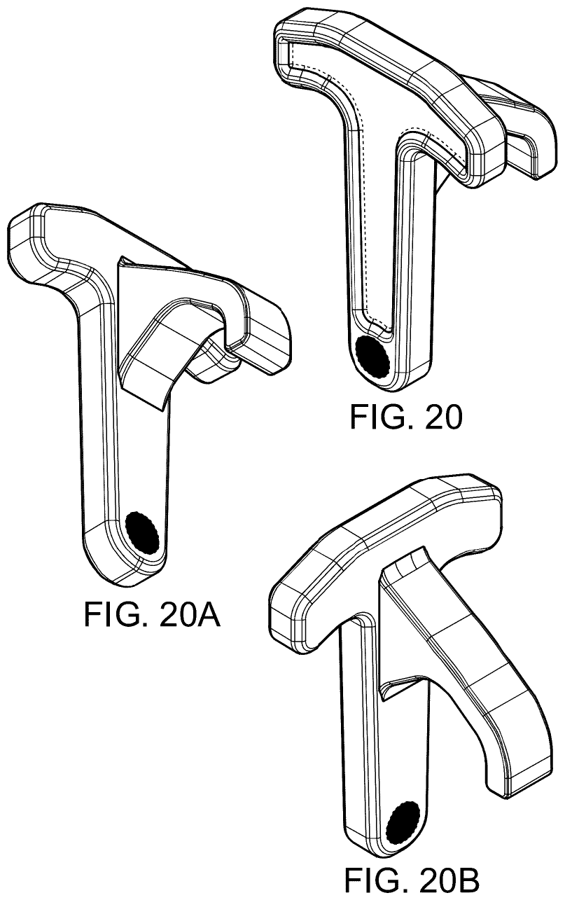

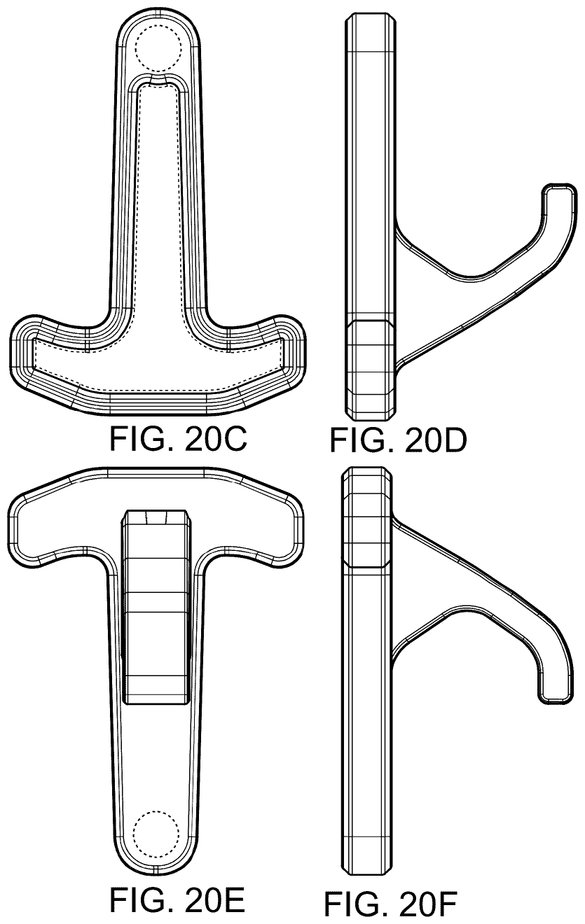

FIG. 19 Through 19F show an alternative version of the handle 16. FIGS. 20 through 2F show another alternative handle 16. FIGS. 21 through 21I show an alternative version of the handle 16 where the hook portion has been reinforced via a skeleton. FIGS. 21J through 21M show a preferred embodiment of the Skeleton. While all of the fundamental characteristics and features of the disclosed securement strap system herein, have been shown herein, with reference to particular embodiments thereof, a latitude of modification, various changes and substitutions are intended in the foregoing disclosure. It will be apparent that in some instances, some features of the disclosed securement strap invention may be employed without a corresponding use of other features without departing from the scope of the invention as set forth.

In a typical method of use, the securement strap system is employed to secure a surfboard to a vehicle roof rack. The system comprises a T-shaped handle and hook attached to a securement strap with a cam buckle at its midpoint and a loop at the distal end. An anchor strap with a 180-degree twisted loop and at least one additional loop along its length is also provided. First, the user wraps the securement strap around a support on the vehicle's roof rack and threads the T-shaped handle through the loop to secure the strap to the support. Next, the user threads the at least one loop of the anchor strap through its own twisted loop, securing it to a mounting point on the vehicle. The user then positions the surfboard on the vehicle's roof rack. Gripping the T-shaped handle with a full hand grip, ensuring the hook extends perpendicular to the handle's axis, the user pulls to stretch the elastic portion of the securement strap. While maintaining this grip, the user guides the hook to engage with either the mounting point on the vehicle or the loop of the anchor strap. Once engaged, the user releases their grip, allowing the elastic portion to constrict. Finally, the user adjusts the cam buckle on the securement strap, lengthening the adjustment portion to achieve the desired compression on the surfboard. If needed, the user slides one or more pliable pads along the strap to position them between the strap and the surfboard for added protection. This process can be repeated with a second strap for additional security, typically positioning the straps near the front and rear of the surfboard. The T-shaped handle utility allows for quick release when needed, enhancing both the securing and releasing processes.

It should also be understood that various substitutions, modifications, and variations may be made by those skilled in the art, upon viewing this disclosure without departing from the spirit or scope of the invention. Consequently, all such modifications and variations and substitutions are considered included within the scope of the invention as defined by the following claims.

What may be claimed may include: A securement strap configured for holding a load upon a vehicle, as shown and described herein.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A method of securing recreational equipment to a vehicle, comprising:
providing a securement strap having a first end and a second end;
attaching a T-shaped handle with a hook to the second end of the securement strap;
positioning the recreational equipment on the vehicle;
stretching an elastic portion of the securement strap;
engaging the hook with a mounting point on the vehicle; and
adjusting the length of the securement strap to compress the recreational equipment against the vehicle.

2. The method of claim 1, further comprising attaching a loop at the first end of the securement strap to a second mounting point on the vehicle.

3. The method of claim 1, further comprising sliding a pliable pad along the securement strap to position between the strap and the recreational equipment.

4. The method of claim 1, wherein adjusting the length of the securement strap comprises manipulating a buckle on a central portion of the strap.

5. The method of claim 4, further comprising covering a slack portion of the strap extending from the buckle with a protective sleeve.

6. The method of claim 1, further comprising providing an anchor strap with a loop at one end and an engagement point at an opposite end.

7. The method of claim 6, further comprising:
attaching the loop of the anchor strap to a vehicle rack; and
engaging the hook of the securement strap with the engagement point of the anchor strap.

8. The method of claim 1, wherein stretching the elastic portion comprises gripping the T-shaped handle with a full hand grip.

9. The method of claim 1, further comprising positioning a buckle cover over a buckle on the securement strap.

10. The method of claim 1, wherein the recreational equipment is selected from the group consisting of a surfboard, kayak, canoe, bicycle, and skis.

11. An apparatus for securing recreational equipment to a vehicle, comprising:
a securement strap having a first end and a second end;
an elastic portion incorporated into the securement strap;
a T-shaped handle attached to the second end of the securement strap;
a hook extending from the T-shaped handle in a plane substantially perpendicular to an axis of the handle; and
an adjustable portion on the securement strap for altering the overall length of the strap.

12. The apparatus of claim 11, further comprising a loop formed at the first end of the securement strap.

13. The apparatus of claim 11, wherein the adjustable portion comprises a buckle through which a portion of the strap is routed in a U-shaped path.

14. The apparatus of claim 13, further comprising a protective sleeve configured to cover a slack portion of the strap extending from the buckle.

15. The apparatus of claim 11, further comprising at least one pliable pad slidably engaged on the securement strap.

16. The apparatus of claim 11, further comprising an anchor strap having a second loop at a first end and an engagement point for the hook at a second end.

17. The apparatus of claim 11, wherein the elastic portion is covered by a fabric sleeve.

18. The apparatus of claim 11, wherein the T-shaped handle comprises a body intersected by a crossbar forming arms that extend perpendicular to the hook.

19. The apparatus of claim 11, further comprising a buckle cover configured to pad the buckle against contact with the recreational equipment or vehicle.

20. A system of rapidly securing and releasing recreational equipment from a vehicle, comprising:
A t-shaped handle and hook attached to a securement strap with a cam buckle at a midpoint and a loop at a distal end, said cam buckle threaded with an adjustment portion of the strap;
An anchor strap with a loop that has an 180 degree twist and at least one loop along the length of the anchor strap;
The system further comprising the steps of:
Wrapping the securement strap around a support on the vehicle and threading the T-shaped handle through the loop to secure the strap to the support;
gripping a T-shaped handle while the hook extends perpendicular to an axis of the handle;
threading the at least one loop of the anchor strap through the loop of the anchor strap so that the anchor strap is secured to a mounting point of the vehicle;
pulling the handle to stretch an elastic portion of the securement strap;
guiding the hook to engage with either the mounting point on the vehicle or the at least one loop of the anchor strap while maintaining a full hand grip on the T-shaped handle;
releasing the full hand grip on the T-shaped handle so that the elastic portion of the securement strap constricts; and,
adjusting the cam buckle on the securement strap to lengthen the adjustment portion of the strap and to compress the recreational equipment.
